(19) United States
(12) Patent Application Publication
(10) Pub. No.: US 2005/0147334 A1
(43) Pub. Date: Jul. 7, 2005

(54) Bearing device and motor using the bearing device

(76) Inventors: Toyoji Kanazawa, Saitama (JP); Chuji Toyoizumi, Saitama (JP)

Correspondence Address: SMITH, GAMBRELL & RUSSELL, LLP, 1850 M STREET, N.W., SUITE 800, WASHINGTON, DC, 20036, US

(21) Appl. No.: 10/510,831

(22) PCT Filed: Apr. 16, 2003
(86) PCT No.: PCT/JP03/04833

(30) Foreign Application Priority Data
Apr. 16, 2002 (JP) 2002-113384
Apr. 16, 2002 (JP) 2002-113371
Apr. 16, 2002 (JP) 2002-113372

(51) Int. Cl. F16C 32/06

(52) U.S. Cl. 384/100

(57) ABSTRACT

A bearing device is composed of a sleeve (3a) for supporting a rotating shaft across a radial axis gap and a housing (3b) formed with a storage hole for storing the sleeve (3a). The sleeve (3a) housed in the storage hole of the housing (3b) is fixed to the housing by applying caulking processing to a part of the inner wall of the housing in a position at a certain downward distance from the upper end of the storage hole.

### TECHNICAL FIELD

The present invention relates to a bearing device applicable to various rotating apparatuses that require non-contact support, such as a microprocessor cooling fan motor, hard disc and optical disc rotating apparatuses, etc., and to a motor using the bearing device.

### BACKGROUND ART

A fluid bearing device that uses dynamic pressure is known to have advantages, such as longer lifetime, quietness, and higher resistance to vibration, which are attributable to non-contact support, as well as higher rotational accuracy. An example of the conventional fluid bearing device that uses dynamic pressure will now be described with reference to FIG. 12A.

A bearing device 101 comprises a sleeve 103a, a housing 103b that supports the sleeve 103a, and a thrust plate 106 fixed to an inside bottom portion of the housing 103b. The sleeve 103a and the housing 103b constitute a bearing member. A rotating shaft 102 is supported in radial and thrust directions by the sleeve 103a and the thrust plate 106. Oil is supplied between the sleeve 103a and the rotating shaft 102. A dynamic pressure groove 131 is formed on the outer peripheral surface of the rotating shaft 102 or the inner peripheral surface of the sleeve 103a. A dynamic pressure is generated by the agency of the dynamic pressure groove 131 and the oil.

When the rotating shaft 102 is rotated, the dynamic pressure groove 131 applies a pumping pressure to the oil. In consequence, the rotating shaft 102 is supported by the pumping pressure and rotates without contact with the sleeve 103a.

In the conventional bearing device shown in FIG. 12A, a portion 105 of the oil sometimes may be caused to scatter or flow out along the outer peripheral surface of the rotating shaft 102 by a rotary force the rotating shaft 102 applies to the oil. If the oil scatters or flows out in this manner, non-contact support becomes difficult.

In order to prevent the oil from leaking out through a gap between the sleeve and the rotating shaft, according to a known technique (e.g., Japanese Patent Application Laid-open No. 11-82487), an oil reservoir is formed by providing an opening on the sleeve side or the rotating shaft side, and this oil reservoir is used to form a seal structure. An example of this oil reservoir will now be described with reference to FIG. 12B. In this example, the oil reservoir that opens upward is formed between the rotating shaft 102 and the upper end portion of the sleeve 103a in a manner such that the diameter of a portion 107 of the rotating shaft 102 that faces the upper end portion of the sleeve 103a is reduced upward. This oil reservoir prevents the oil from overflowing it by the agency of a centrifugal force and from escaping along the surface of the rotating shaft 102.

According to this prior art technique in which a seal portion is formed by defining a space for the oil reservoir between the sleeve and the rotating shaft, however, plenty of the oil may possibly collect in the oil reservoir and plenty of the oil may run out of the oil reservoir. Thus, it is hard to satisfactorily produce the effect of preventing dispersion of the oil.

FIG. 13 shows an example in which a fan motor is formed by fixing a rotor 111, having a fan 116 mounted on its outer periphery, to a rotating shaft 102, and which is disclosed in Japanese Utility Model Application Laid-open No. 2-94922. A magnet 112 attached to the rotor 111 and a coil 113 provided on the side of the sleeve 103a are arranged with a space in the axial direction of the rotating shaft 102 between them. By doing this, a force of magnetic attraction that urges the rotating shaft 102 downward is generated. This force of magnetic attraction acts on the rotating shaft 102 so as to prevent it from slipping out of the sleeve 103a.

If a force, such as vibration or impact, acts on the bearing device 101 or if the bearing device 101 is tilted, it is hard for only the force of magnetic attraction to prevent the rotating shaft 102 from slipping off. Accordingly, the rotating shaft 102 is prevented from slipping out of the sleeve 103a by attaching a flange 105 to the lower end of the rotating shaft 102. Thus, if the rotating shaft 102 is moved upward by an external force, the flange 105 that is fixed to the rotating shaft 102 engages a part of the sleeve 103a, so that the rotating shaft 102 is prevented from further moving upward.

If the force of magnetic attraction is enhanced to prevent the rotating shaft from slipping off, in the prior art example described above, a substantial pressure acts between a pivot end and a pivot receiving portion of the rotating shaft. Thus, friction on the pivot portion increases to generate dynamic friction, and besides, the rotation of the rotating shaft is liable to be unbalanced. If the flange engages the sleeve, moreover, the rotation of the rotating shaft is suddenly braked, so that the flange and the bearing member are heated by friction, and besides, the flange and the bearing member may possibly be broken.

Disclosed in Japanese Patent Application Laid-open Nos. 9-37513 and 9-32850, moreover, is a technique in which a rotating shaft is provided with a thrust dynamic pressure bearing in order to prevent the rotating shaft from slipping off. This prior art technique will be described with reference to FIG. 14. In FIG. 14, a flange 105 is provided in a given height position on a rotating shaft 102. Dynamic pressure grooves 105a and 105b are formed individually on the upper and lower surfaces of the flange 105. The flange 105 is located in a space that is defined in a sleeve 103a, and this space is filled with oil. If the rotating shaft 102 is rotated, vertical thrust dynamic pressures in upward and downward directions are generated along the axial direction of the rotating shaft 102. The rotating shaft 102 is retained by this thrust dynamic pressure.

According to the prior art example described above, it is hard to accurately form the space for the flange. Since the flange continually generates the dynamic pressures in both the upward and downward directions, moreover, a great power loss is caused inevitably.

The sleeve that rotatably supports the rotating shaft is fixed to the housing. Disclosed in Japanese Patent Application Laid-open No. 2000-352412, for example, is a method in which the sleeve is fixed to the housing by a technique such that a part of the housing is plastically deformed by caulking processing. This technique will be explained with reference to FIGS. 15A to 15C.

A housing 103b is provided with a storage hole 108 in which the sleeve 103a is stored. An upper end portion 103b1 of the housing 103b is thin-walled throughout its circumference. After the sleeve 103a is housed in the storage hole 108 (FIG. 15B), the upper end portion 103b1 of the housing 103b is subjected to caulking processing (FIG. 15C), and the upper end face of the sleeve 103a is pressed with the plastically deformed upper end portion 103b1.

This fixation of the sleeve 103a based on the caulking processing is achieved by plastically deforming the upper end portion 103b1 of the housing 103b inward throughout the circumference. In some cases, therefore, other parts of the housing 103b than the upper end portion 103b1 may be deformed as the upper end portion 103b1 of the housing 103b is plastically deformed, as indicated by the circle in FIG. 15C. The deformation of the housing 103b causes deformation of the sleeve 103a and renders the gap between the rotating shaft 102 and the sleeve 103a uneven.

### DISCLOSURE OF THE INVENTION

The object of the present invention is to provide a bearing device, in which an escape of a liquid fluid (oil) is reduced, a rotating shaft is securely prevented from slipping off, and deformation of a housing is restrained when a sleeve is fixed to the housing by caulking processing, and a motor using the bearing device.

In order to achieve the above object, a bearing device according to the present invention comprises a sleeve for supporting a rotating shaft across a radial axis gap and a housing formed with a storage hole for storing the sleeve, wherein the sleeve stored in the storage hole of the housing is fixed to the housing by applying caulking processing to a part of the inner wall of the housing in a position at a certain downward distance from the upper end of the storage hole.

The bearing device according to the present invention may assume the following aspects.

The inner wall of the housing constituting the storage hole has a first inner peripheral surface having an inside diameter substantially equal to the outside diameter of the sleeve and a second inner peripheral surface having an inside diameter larger than that of the first inner peripheral surface such that the first and second inner peripheral surfaces are located on the bottom side and the inlet side, respectively, of the storage hole, and the sleeve is fixed to the housing by applying caulking processing to a part of a step portion formed in a boundary region between the first and second inner peripheral surfaces.

A part of the first inner peripheral surface and a part of the second inner peripheral surface radially overlap each other in the boundary region, and the overlapping parts are subjected to caulking processing at least partially.

The wall thickness of the overlapping parts is reduced upward.

The sleeve is formed with a radially parallel upper end face on the outer peripheral portion thereof, and a part of the inner wall of the housing is subjected to caulking processing toward the upper end face thereof.

The sleeve is formed so that the central portion thereof is higher than the outer peripheral portion, and a slope is formed between the central portion and the outer peripheral portion.

The bottom portion of the housing is formed with a bottom space in which a liquid fluid is collected such that oil in the bottom space is fed into the radial axis gap by capillary action.

The housing and/or the sleeve is provided with a communication hole having one end opening into the atmosphere and the other end communicating with the bottom space so that the liquid fluid having overflowed the upper end of the radial axis gap returns to the bottom space through the communication hole.

The one end of the communication hole opens in the upper end face of the outer periphery portion of the sleeve.

The bottom space has an inside diameter smaller than the diameter of the first inner peripheral surface so that a step is formed between the first inner peripheral surface and the inner peripheral surface of the bottom space, and the position of the sleeve in the storage hole of the housing is settled by placing the lower end face of the sleeve on the step.

The rotating shaft is supported in the sleeve, and a flange is fixed to the rotating shaft and located in a bottom space defined at the bottom portion of the housing.

The rotating shaft is supported in the sleeve, and a fan is fixed to the rotating shaft. Further, a motor is formed by using this bearing device.

The bearing device comprises a rotating shaft and a radial bearing surface opposed to the outer peripheral surface of the rotating shaft across a radial axis gap filled with a liquid fluid in order to support at least a radial load of the rotating shaft, wherein the rotating shaft is formed with a step portion in a certain height position such that a part of the rotating shaft, which is exposed upward from the radial axis gap, has a step portion formed at a certain height position thereof so that the portion above the height position is thinner than the portion below the height position.

A part of the rotating shaft, which ranges from the step portion to the lower end, has a constant diameter.

The rotating shaft is formed with the step portion by narrowing or widening a part of the portion exposed from the radial axis gap.

The upper surface of the step portion is a flat surface perpendicular to the axis of the rotating shaft.

The upper surface of the step portion is a flat surface inclined with respect to the axis of the rotating shaft.

The upper surface of the step portion is a curved surface.

The curved surface is continuous with outer peripheral surfaces below and above the step portion of the rotating shaft.

### BRIEF DESCRIPTION OF THE DRAWINGS

FIG. 1 is a sectional view for illustrating an outline of a bearing device according to the present invention;

FIG. 2 is a view illustrating the way a rotating shaft of the bearing device according to the present invention is divided between a large-diameter lower portion and a small-diameter upper portion by a step portion;

FIGS. 3 to 5 are views individually showing rotating shafts having step portions of shapes different from that of the step portion on the rotating shaft of FIG. 2;

FIGS. 6 and 7 are views individually showing a step portion of a rotating shaft formed according to another embodiment of the bearing device of the present invention;

FIGS. 8A and 8B are a top view and a sectional view, respectively, showing an example of a communication hole defined between a sleeve and a housing, through which oil is returned to an underlying bottom space;

FIGS. 9A and 9B are a top view and a sectional view, respectively, showing another example of the communication hole;

FIGS. 10A and 10B are views illustrating a rotating shaft holding mechanism of the bearing device according to the present invention, based on thrust dynamic pressure;

FIGS. 11A to 11C are sectional views illustrating the way the sleeve is fixed to the housing by caulking processing in the bearing device according to the present invention;

FIG. 12A is a sectional view illustrating the way oil scatters from a gap between a sleeve and a rotating shaft in a conventional bearing device that utilizes dynamic pressure;

FIG. 12B is a sectional view illustrating a prior art example in which an oil reservoir is formed on the rotating shaft side in order to prevent leakage of the oil;

FIG. 13 is a sectional view for illustrating an example of a prior art bearing device in which a rotating shaft is provided with a flange for preventing the rotating shaft from slipping off;

FIG. 14 is a sectional view for illustrating an example of a prior art bearing device provided with a thrust dynamic pressure bearing for preventing a rotating shaft from slipping off; and

FIGS. 15A to 15C are sectional views illustrating the way a sleeve is fixed to a housing by caulking processing according to a prior art technique.

### BEST MODE FOR CARRYING OUT THE INVENTION

(General Construction of Bearing Device)

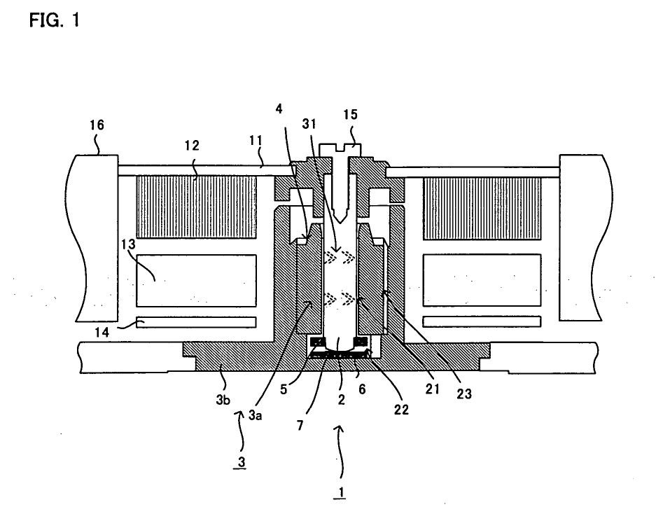

An example of a bearing device according to the present invention that is applied to a fan motor will first be described with reference to FIG. 1.

A bearing device 1 comprises a rotating shaft 2 and a bearing member 3 that supports the rotating shaft 2 for rotation. The bearing member 3 includes a sleeve 3a, which supports the rotating shaft 2 in a non-contact manner, and a housing 3b that fixes the sleeve 3a. A rotor 11 that is fitted with a fan 16 is fixed to the rotating shaft 2 by means of a fixing screw 15, whereby the fan motor is formed.

A magnet 12 on the rotor 11, a coil and a magnetic core 13, which are attached to a fixed portion of the housing 3b, and a base plate 14 that controls drive current to the coil constitute a fan motor drive mechanism.

The sleeve 3a is penetrated by a storage hole that houses the rotating shaft 2. When the rotating shaft 2 is housed in the storage hole, a radial axis gap 21 is defined between the inner peripheral surface (radial dynamic pressure receiving surface) of the storage hole of the sleeve 3a and the outer peripheral surface of the rotating shaft 2 that is housed in the storage hole. If a liquid fluid (hereinafter referred to as oil) such as oil is fed into the radial axis gap 21, the rotating shaft 2 can rotate without contact with the sleeve 3a.

A dynamic pressure groove 31 for dynamic pressure generation, such as a herringbone groove, is formed on the outer peripheral surface of the rotating shaft 2 and/or the inner peripheral surface of the rotating shaft storage hole of the sleeve 3a that face each other with the radial axis gap 21 between them. In the example of FIG. 1, the dynamic pressure groove 31 is formed on the outer peripheral surface of the rotating shaft 2. If the rotating shaft 2 is rotated with the radial axis gap 21 filled with oil, a dynamic pressure is generated by the agency of the dynamic pressure groove 31 and the oil, and the rotating shaft 2 is supported in a non-contact manner by the dynamic pressure.

The housing 3b has a space 22 at its bottom portion in which the oil to be fed into the radial axis gap 21 is collected. The bottom space 22 communicates with the rotating shaft storage hole of the sleeve 3a. Arranged in the bottom space 22, moreover, are the lower end portion of the rotating shaft 2 and a flange 5 that is fixed to the lower end portion of the rotating shaft 2. Located on the bottom surface of the bottom space 22 is a thrust plate 6, which point-supports a pivot portion 7 at the lower end of the rotating shaft 2.

The oil that is collected in the bottom space 22 of the housing 3b is fed into the radial axis gap 21 by capillary action. At respective communicating portions of the radial axis gap 21 and the bottom space 22, the capacity of the bottom space 22 is made larger enough than the capacity of the radial axis gap 21. By doing this, a force to feed the oil into the radial axis gap 21 can be generated by capillary action.

Further, a communication hole 23 is defined between the sleeve 3a and the housing 3b. If the oil rises in the radial axis gap 21 and overflows the upper end of the radial axis gap 21, it is returned to the bottom space 22 through the communication hole 23.

(Forming Step Portion on Rotating Shaft)

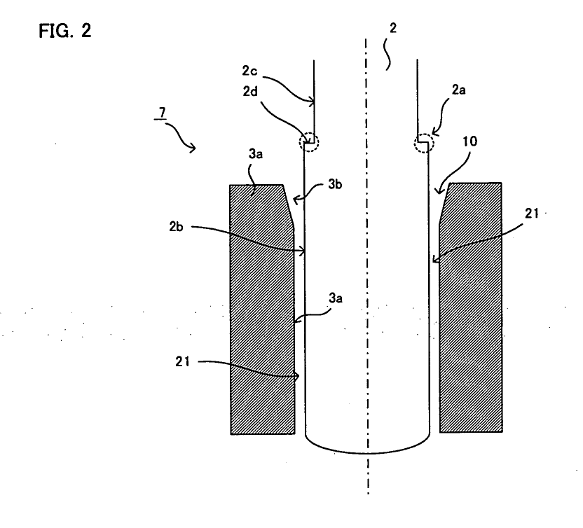

Of the part of the rotating shaft 2 exposed upwardly out of the sleeve 3a, a portion of that part above a certain level or a boundary is made thinner than a portion of that part below the level. Thus, the rotating shaft 2 is composed of a large-diameter lower portion 2b and a small-diameter upper portion 2c, with a step portion 2a serving as a boundary. A part of the lower portion 2b of the rotating shaft 2 is opposed to the housing 3b, while the remaining part is exposed upward from the upper end of the housing 3b. A surface (stepped surface 2d) that forms the step portion 2a is within a plane that is perpendicular to the axis of the rotating shaft 2 indicated by dashed line in FIG. 2.

The upper end portion of the inner peripheral surface of the sleeve 3a forms a slope 3b and defines a space (oil reservoir 10) that opens upward between itself and the rotating shaft 2. The oil fed into the radial axis gap 21 by capillary action rises in the radial axis gap 21 and is collected in the oil reservoir 10. The oil collected in the oil reservoir 10 further rises on the outer peripheral surface of the rotating shaft 2 in the course of rotation and reaches the step portion 2a.

A centrifugal force that is produced by the rotation of the rotating shaft 2 acts on the oil on the outer peripheral surface of the rotating shaft 2, that is, a force acts away from the axis of the rotating shaft 2. If the oil rises on the outer peripheral surface of the rotating shaft 2 and reaches the step portion 2a, therefore, the oil never advances on the stepped surface 2d in the direction opposite to the direction in which the centrifugal force acts. Thus, the oil is restrained from advancing on the stepped surface 2d and reaching the lower end of the upper portion 2c of the rotating shaft 2.

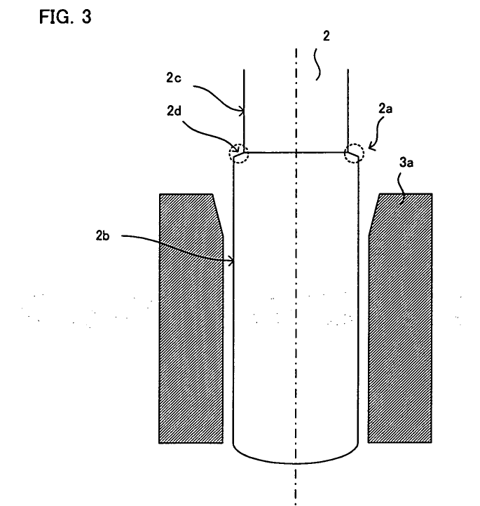

FIGS. 3 to 7 show alternative modes of the step portion 2a that is formed on the rotating shaft 2.

The stepped surface 2d of a step portion 2a shown in FIG. 3 is not a surface perpendicular to the axis (indicated by dashed line) of the rotating shaft 2, but is a flat surface that is inclined downward.

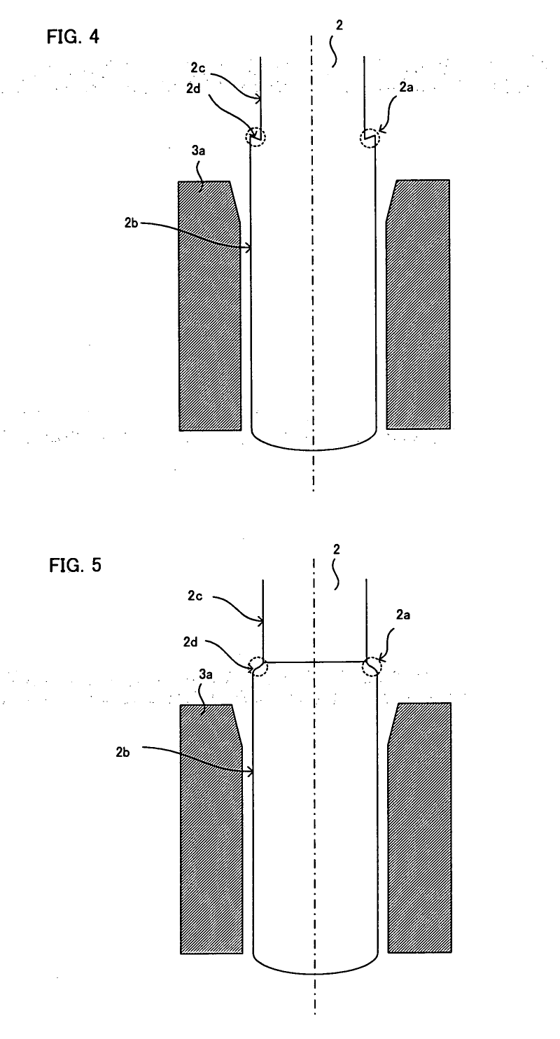

The stepped surface 2d of a step portion 2a shown in FIG. 4 is not a surface perpendicular to the axis (indicated by dashed line) of the rotating shaft 2, but is a flat surface that is inclined upward.

In a step portion 2a shown in FIG. 5, its stepped surface 2d is a curved surface, not a flat surface, so that its lower portion 2b having a larger outside diameter smoothly changes into its upper portion 2c having a smaller outside diameter via the step portion 2a.

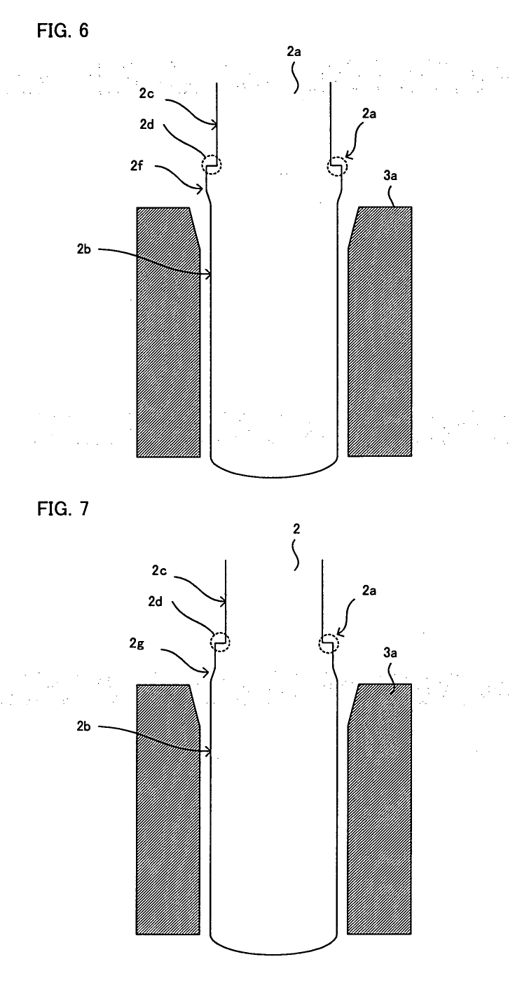

A rotating shaft 2 shown in FIG. 6 is composed of a lower portion 2b, a central portion 2f, and an upper portion 2c. The lower portion 2b faces the inner peripheral surface of the sleeve. The central portion 2f is continuous with the upper part of the lower portion 2b and has an outside diameter a little larger than that of the lower portion 2b. The upper portion 2c connects with the central portion 2f through a step portion 2a and has an outside diameter smaller than that of the central portion 2f.

A rotating shaft 2 shown in FIG. 7 is composed of a lower portion 2b, a central portion 2g, and an upper portion 2c. The lower portion 2b faces the inner peripheral surface of the sleeve. The central portion 2g is continuous with the upper part of the lower portion 2b and has an outside diameter a little smaller than that of the lower portion 2b. The upper portion 2c connects with the central portion 2f through a step portion 2a and has an outside diameter smaller than that of the central portion 2f.

In any of the above examples shown in FIGS. 2 to 7, the step portion 2a is formed in an optional position on the rotating shaft 2 exposed from the sleeve 3a so that the parts above and below the step portion are different in outside diameter. Thus, the action of the centrifugal force of the rotating shaft 2 in the course of rotation is utilized to restrain the oil from advancing on the stepped surface 2d of the step portion 2a and reaching the portion 2c of the rotating shaft 2 above the step portion 2a.

(Supplying Oil to Radial Axis Gap)

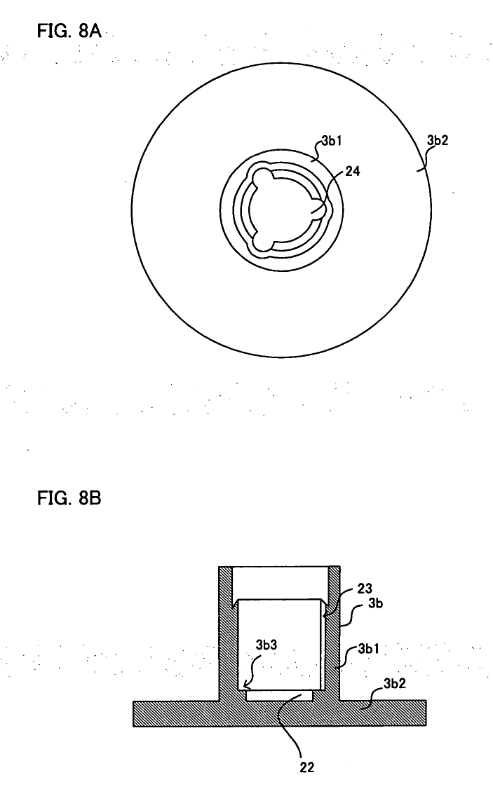

As shown in FIG. 8B, the housing 3b is composed of a housing cylinder portion 3b1 that houses the sleeve 3a therein and a housing bottom portion 3b2 that is formed at the bottom of the housing cylinder portion 3b1.

A shoulder portion 3b3 is formed inside the lower end of the housing cylinder portion 3b1. When the lower end face of the sleeve 3a engages the shoulder portion 3b3, the position where the sleeve 3a is stored in the housing 3b is settled. The inner peripheral surface of the shoulder portion 3b3, the bottom surface of the sleeve 3a that is positioned by the shoulder portion 3b3, and the bottom surface of the housing cylinder portion 3b1 define the bottom space 22 in which the oil to be fed into the radial axis gap 21 is collected.

As the oil is filled into the bottom space 22 to reach a position higher than a lower end opening of the radial axis gap 21, the oil gets into the radial axis gap 21 by capillary action.

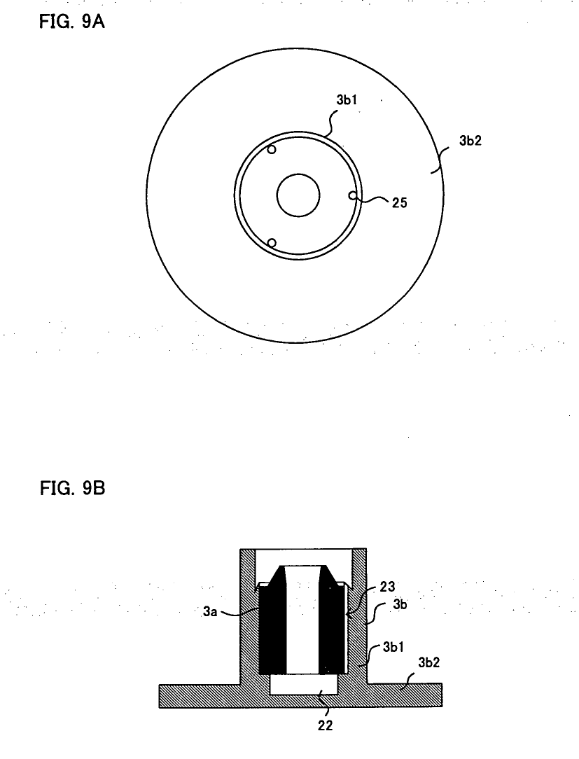

The communication hole 23 (see FIG. 1) for returning the oil, having overflowed the radial axis gap 21, to the bottom space 22 can be formed by forming grooves 24 on an inner peripheral wall of a housing cylinder portion 4b, as shown in FIGS. 8A and 8B, or by forming grooves 25 on an outer peripheral wall of the sleeve 3a, as shown in FIGS. 9A and 9B. The grooves 24 and 25 that constitute the communication hole 23 are given an inside diameter large enough not to allow the oil in the bottom space 22 to be sucked up by capillary action.

(Generation of Thrust Dynamic Pressure)

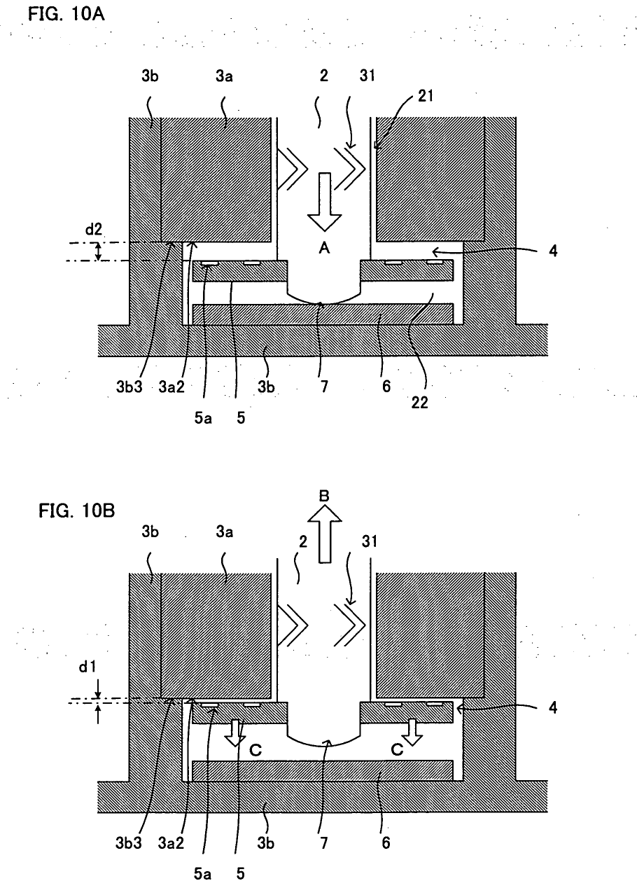

As shown in FIG. 1, the magnet 12 and the coil and magnetic core 13 are arranged at an interval in the axial direction of the rotating shaft 2, whereby the force of magnetic attraction that urges the rotating shaft 2 downward is generated. In FIG. 10A, the force of magnetic attraction is indicated by arrow A. In this state, the pivot portion 7 at the lower end of the rotating shaft 2 abuts against the thrust plate 6. The thrust plate 6 is formed of a low-friction material and point-supports the pivot portion 7.

As shown in FIG. 10A, the flange 5 is mounted on that part of the rotating shaft 2 which is exposed below the lower end face of the sleeve 3a (i.e., in the bottom space 22). A thrust dynamic pressure groove 5a is formed on the upper surface of the flange 5. When the rotating shaft 2 is lowered by the agency of the force of magnetic attraction in the aforesaid direction of arrow A so that the pivot portion 7 at its lower end touches the thrust plate 6, as shown in FIG. 10A, an interval d2 between a lower end face 3a2 of the sleeve 3a and the upper surface of the flange 5 increases. Even if the flange 5 rotates with respect to the sleeve 3a in the bottom space 22 that is filled with the oil, therefore, hardly any dynamic pressure is generated.

If vibration or shock acts on the bearing device 1 or if the bearing device 1 is subjected to any external force as its posture is changed, on the other hand, a force in the direction (direction of arrow B) opposite to the direction of the force of magnetic attraction acts on the rotating shaft 2, as shown in FIG. 10B, thereby raising the rotating shaft 2 with respect to the sleeve 3a and urging it to be disengaged from the sleeve 3a. When the rotating shaft 2 ascends, an interval d1 between the lower end face 3a2 of the sleeve 3a and the upper surface of the flange 5 lessens. If the flange 5 rotates with respect to the sleeve 3a in the bottom space 22 that is filled with the oil, therefore, a dynamic pressure is generated. The dynamic pressure thus generated serves to press the flange 5 downward (i.e., in the direction indicated by arrow C in FIG. 10B).

When the flange 5 (and the rotating shaft 2) is depressed by the dynamic pressure, the interval between the lower end face 3a2 of the sleeve 3a and the upper surface of the flange 5 increases. If the interval between the lower end face 3a2 of the sleeve 3a and the upper surface of the flange 5 thus increases, the dynamic pressure lowers. In consequence, the flange 5 is stabilized in a position where the sum of the external force applied to the bearing device 1 and the force of magnetic attraction (or the sum total of forces that serve to raise the rotating shaft 2) is balanced with the dynamic pressure (force that serves to lower the rotating shaft 2). If the external force applied to the bearing device 1 is removed, only the force of magnetic attraction (in the direction of arrow A) acts on the rotating shaft 2, so that the flange 5 returns to the position of FIG. 10A.

(Fixing Sleeve to Housing)

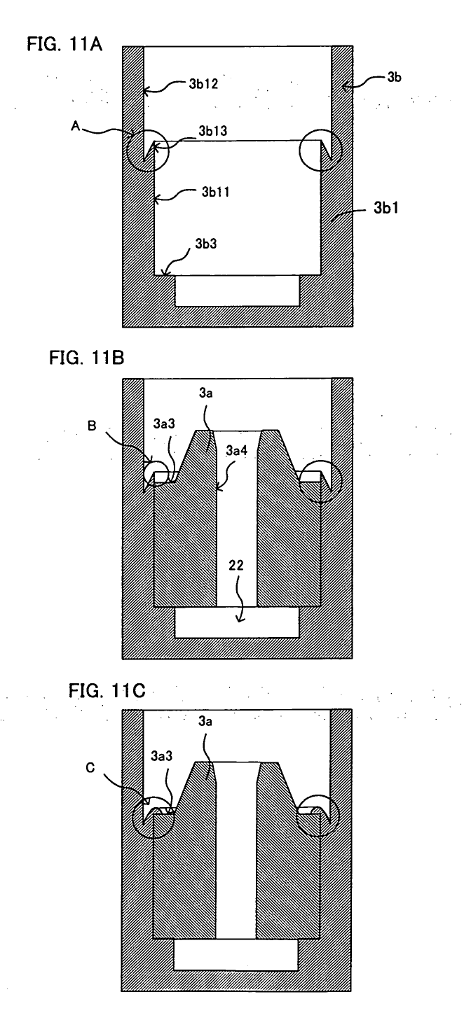

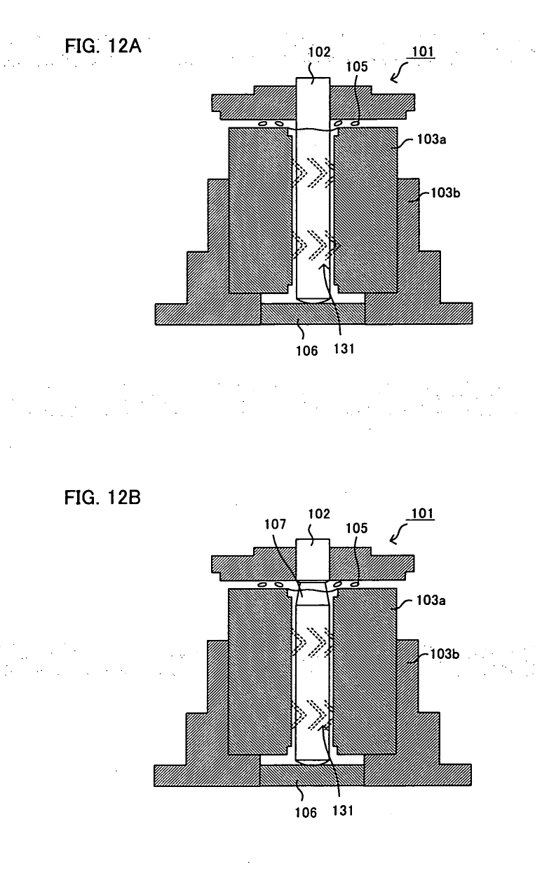

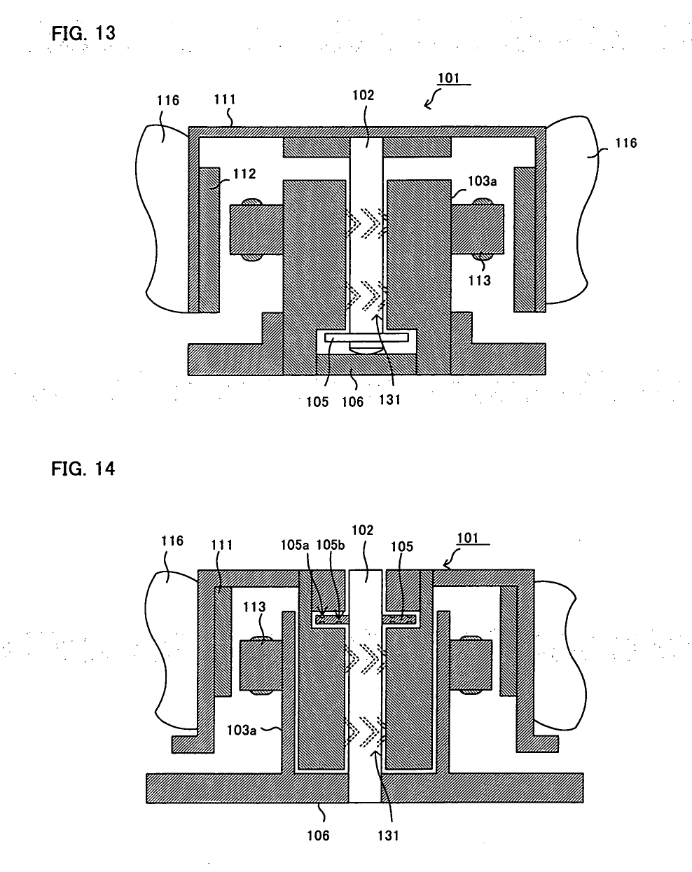

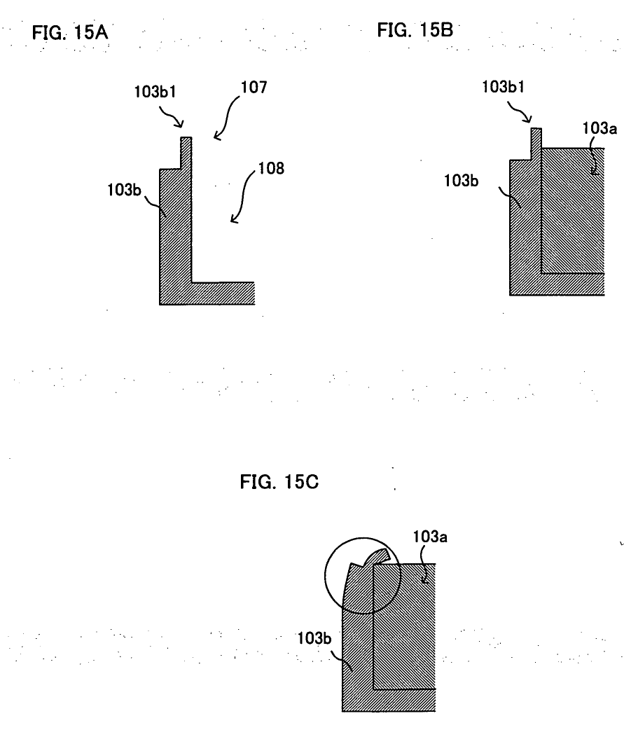

As shown in FIG. 11A, the inner wall of housing cylinder portion 3b1 of the housing 3b is formed with a first inner peripheral surface 3b11 and a second inner peripheral surface 3b12. The first inner peripheral surface 3b11 receives the sleeve 3a and faces the outer peripheral surface of the sleeve 3a. The second inner peripheral surface 3b12 is continuous with the upper part of the first inner peripheral surface 3b11 and has an inside diameter larger than that of the first inner peripheral surface 4a. The lower end portion of the second inner peripheral surface 3b12 and the upper end portion of the first inner peripheral surface 3b11 are located radially overlapping each other, as indicated by circle A in FIG. 11A. Thus, a projection 3b13 is formed between the first inner peripheral surface 3b11 and the second inner peripheral surface 3b12 so as to project diagonally upward toward the axis of the housing 3b.

If the sleeve 3a is put into the housing 3b so that the lower end face of the sleeve 3a engages the shoulder portion 3b3 that is formed inside the lower end of the housing 3b, as shown in FIG. 11B, moreover, the sleeve 3a faces the first inner peripheral surface 3b11 of the inner wall of the housing 3b and the basal part of the projection 3b13 that is continuous with it. However, an upper surface 3a3 of the outer peripheral portion of the sleeve 3a never reaches the distal end portion of projection 3b13 that is formed on the inner wall surface of the housing. Thus, at least the distal end portion of the projection 3b13 never faces the sleeve 3a, as indicated by circle B in FIG. 11B. As shown in FIG. 11C, therefore, the sleeve 3a can be fixed in the housing 3b by plastically deforming the distal end portion of the projection 3b13 toward the upper surface 3a3 of the outer peripheral portion of the sleeve 3a by caulking processing (see circle C). Thus, the lower end face and the upper surface 3a3 of the outer peripheral portion of the sleeve 3a are positioned by the shoulder portion 3b3 and the distal end portion of the plastically deformed projection 3b13, respectively, and fixed to the housing 3b.

As the distal end portion of the projection 3b13, which is to be subjected to caulking processing, is reduced in thickness toward the distal end edge, the caulking processing is easy. Besides, the projection 3b13 is formed in the inner wall of the housing 3b at an intermediate portion thereof in the height direction. Thus, in applying caulking processing to the distal end portion of the projection 3b13, there is no possibility of any other parts of the housing 3b being deformed. Accordingly, occurrence of a phenomenon such that the gap distance between the sleeve 3a and the rotating shaft 2 varies by the caulking processing can be prevented.

As shown in FIGS. 11B and 11C, the distal end portion of the projection 3b13, which has been subjected to caulking processing, abuts against the upper surface 3a3 of the outer peripheral portion of the sleeve 3a, which is lower than its central portion. The central portion of the sleeve 3a is penetrated by a storage hole 3a4 that houses the rotating shaft 2. Since the sleeve 3a has this construction, the region (upper surface 3a3 of the outer peripheral portion) in which the projection 3b13, which has been subjected to caulking processing, engages the sleeve 3a can be located below the upper end of the storage hole 3a4 of the sleeve 3a.

The projection 3b13 may be formed ring-shaped covering the whole circumference of the inner wall of the housing 3b or formed only on a part of the circumference of the inner wall of the housing 3b.

1. A bearing device which comprises a sleeve for supporting a rotating shaft across a radial axis gap and a housing formed with a storage hole for storing the sleeve, wherein
said sleeve stored in the storage hole of said housing is fixed to the housing by applying caulking processing to a part of the inner wall of the housing in a position at a certain downward distance from the upper end of the storage hole.

2. The bearing device according to claim 1, wherein the inner wall of the housing constituting said storage hole has a first inner peripheral surface having an inside diameter substantially equal to the outside diameter of said sleeve and a second inner peripheral surface having an inside diameter larger than that of the first inner peripheral surface such that the first and second inner peripheral surfaces are located on the bottom side and the inlet side, respectively, of said storage hole, and said sleeve is fixed to the housing by applying caulking processing to a part of a step portion formed in a boundary region between said first and second inner peripheral surfaces.

3. The bearing device according to claim 2, wherein a part of said first inner peripheral surface and a part of said second inner peripheral surface radially overlap each other in said boundary region, and the overlapping parts are subjected to caulking processing at least partially.

4. The bearing device according to claim 2, wherein the wall thickness of said overlapping parts is reduced upward.

5. The bearing device according to claim 1, wherein said sleeve is formed with a radially parallel upper end face on the outer peripheral portion thereof, and a part of the inner wall of the housing is subjected to caulking processing toward the upper end face thereof.

6. The bearing device according to claim 5, wherein said sleeve is formed so that the central portion thereof is higher than said outer peripheral portion, and a slope is formed between the central portion and the outer peripheral portion.

7. The bearing device according to claim 1, wherein the bottom portion of said housing is formed with a bottom space in which a liquid fluid is collected such that oil in the bottom space is fed into said radial axis gap by capillary action.

8. The bearing device according to claim 7, wherein said housing and/or said sleeve is provided with a communication hole having one end opening into the atmosphere and the other end communicating with said bottom space so that the liquid fluid having overflowed the upper end of the radial axis gap returns to said bottom space through the communication hole.

9. The bearing device according to claim 8, wherein the one end of said communication hole opens in the upper end face of the outer periphery portion of said sleeve.

10. The bearing device according to claim 7, wherein said bottom space has an inside diameter smaller than the diameter of said first inner peripheral surface so that a step is formed between the first inner peripheral surface and the inner peripheral surface of said bottom space, and the position of the sleeve in the storage hole of the housing is settled by placing the lower end face of said sleeve on the step.

11. The bearing device according to claim 1, wherein the rotating shaft is supported in said sleeve, and a flange is fixed to the rotating shaft and located in a bottom space defined at the bottom portion of said housing.

12. The bearing device according to claim 1, wherein the rotating shaft is supported in said sleeve, and a fan is fixed to the rotating shaft.

13. The motor using the bearing device according to claim 12.

14. The bearing device according to claim 1, in which the bearing device comprises a rotating shaft and a radial bearing surface opposed to the outer peripheral surface of said rotating shaft across a radial axis gap filled with a liquid fluid in order to support at least a radial load of the rotating shaft, wherein
the rotating shaft is formed with a step portion in a certain height position such that a part of the rotating shaft, which is exposed upward from said radial axis gap, has a step portion formed at a certain height position thereof so that the portion above the height position is thinner than the portion below the height position.

15. The bearing device according to claim 14, wherein a part of the rotating shaft, which ranges from said step portion to the lower end, has a constant diameter.

16. The bearing device according to claim 14, wherein said rotating shaft is formed with said step portion by narrowing or widening a part of the portion exposed from said radial axis gap.

17. The bearing device according to claim 14, wherein the upper surface of said step portion is a flat surface perpendicular to the axis of the rotating shaft.

18. The bearing device according to claim 14, wherein the upper surface of said step portion is a flat surface inclined with respect to the axis of the rotating shaft.

19. The bearing device according to claim 14, wherein the upper surface of said step portion is a curved surface.

20. The bearing device according to claim 19, wherein said curved surface is continuous with outer peripheral surfaces below and above said step portion of the rotating shaft.
